(19) United States
(12) Patent Application Publication
(10) Pub. No.: US 2023/0299517 A1
(43) Pub. Date: Sep. 21, 2023

(54) GLASS PRODUCT, CONNECTOR, AND METHOD OF INSTALLING CONNECTOR

(71) Applicant: CARLEX GLASS AMERICA, LLC, Nashville, TN (US)

(72) Inventors: Steven Scott CHRISTMAN, Nashville, TN (US); Olivier FARREYROL, Wasserbillig (LU)

(21) Appl. No.: 18/018,391

(22) PCT Filed: Jul. 28, 2021
(86) PCT No.: PCT/US2021/043421

§ 371 Date: Jan. 27, 2023

Related U.S. Application Data
(60) Provisional application No. 63/058,171, filed on Jul. 29, 2020.
(60) Provisional application No. 63/058,190, filed on Jul. 29, 2020.

(51) Int. Cl. H01R 12/53; H01R 4/70

(52) U.S. Cl. CPC H01R 12/53; H01R 4/70

(57) ABSTRACT

A glass product, comprising: a glazing having a connectable material with a connecting surface on the glazing; a connector over the connecting surface including: a sleeve having an opening therethrough adhered over the connecting surface via a first adhesive; and a fitting which fits at least partially within the sleeve and includes a connector plate on a bottom surface and an extension extending from the fitting; and a conductive material within the sleeve; at least part of the conductive material being positioned between the connector plate and the connecting surface.

### CROSS REFERENCE TO RELATED APPLICATIONS

This application claims priority to U.S. Provisional Patent Application No. 63/058,171, filed on Jul. 29, 2020, entitled “Electrical Connector,” and U. S. Provisional Patent Application No. 63/058J90, tiled on Jul. 29, 2020, entitled “Electrical Connector,” the entire contents of which are incorporated by reference herein in their entirety.

### TECHNICAL FIELD

The present disclosure generally relates to glass products, electrical connectors, and methods of installing such electrical connectors.

### BACKGROUND

Traditionally, electrical connectors have been soldered to electrically conductive materials in automotive glass via lead-containing solder. However, new directives have instituted use of lead-free solders, which have proven difficult, as mechanical stresses at the connectors lead to cracks in an underlying glass. U.S. Pat. No. 9,520,665 (the '665 patent) discloses an electrical connector attached to a glass plate with a conductive rubber at least partially surrounded by a thermosetting adhesive on the underside of the connector. The process described in the '665 patent uses heat and pressure from an autoclaving process during glass lamination to adhere the connector to glass.

### SUMMARY OF THE DISCLOSURE

Disclosed herein is a connector, including: a sleeve having an opening therethrough; and a fitting which fits within the wherein the fitting includes a connector plate on a bottom surface and an extension (a terminal) extending from the fitting.

Also disclosed herein is a glass product, including: a glazing having a connectable material with a connecting surface on the glazing; the connector mentioned above over the connecting surface, wherein the sleeve is adhered over the connecting surface via a first adhesive; and a conductive material within the sleeve; at least part of the conductive material being positioned between the connector plate and the connecting surface.

In some embodiments, the sleeve may include at least one void in an interior wall of the sleeve and the fitting may include at least one clip which corresponds to the at least one void.

In certain embodiments, the at least one clip may be partially surrounded by an opening in the fitting.

In certain embodiments, the fitting may include an inner piece and an outer shell, and the at least one clip may be formed as part of the inner piece and extends out of the outer shell.

In certain embodiments, the sleeve may include at least two voids, and the fitting may include at least two clips, and the number of voids may be equal to the number of clips. Alternatively, the sleeve may include one void which ends around a majority or all of the sleeve.

In certain embodiments, the connector may further include a gasket around the fitting. The at least one void may be at least one pocket or through hole.

In certain embodiments, a first adhesive may be provided on a bottom surface of the sleeve. The fitting may include a top portion for positioning over the sleeve; and a second adhesive may be provided on at least one of the top portion of the fitting and a top surface of the sleeve.

In certain embodiments, the first adhesive and the second adhesive may be the same material.

In certain embodiments, the connector plate may be press fit into the fitting. The opening of the sleeve and the fitting may have a circular shape. The sleeve a and the fitting may be the same color.

Also disclosed herein is a method of installing the connector mentioned above, including: positioning the sleeve on a glazing over a connecting surface with a first adhesive between the sleeve and the glazing; dispensing a conductive material in the opening of the sleeve; and pushing the fitting into the sleeve, over the conductive material such that the connector plate is in contact with the conductive material.

In certain embodiments, the conductive material may fill a space between the connector plate and the glazing. The first adhesive may be cured prior to dispensing the conductive material in the opening of the sleeve.

In certain embodiments, a second adhesive may be in contact with the fitting and the sleeve. The second adhesive may be provided on the fitting or on a top surface of the sleeve. The method may further include curing the second adhesive. The first adhesive may be provided on a b surface of the sleeve.

### BRIEF DESCRIPTION OF THE DRAWINGS

The accompanying drawings, which are incorporated into and constitute a part of this specification, illustrate one or more aspects of the present disclosure and, together with the detailed description, serve to explain their principles and implementations.

FIG. 1 is a plan view illustrating a fitting, according to an exemplary aspect of the present disclosure;

FIG. 2 is a plan view illustrating a fitting, according to an exemplary aspect of the present disclosure;

FIG. 3 is a cross section view illustrating a portion of a fitting, according to an exemplary aspect of the present disclosure;

FIG. 4 illustrates a portion of a fitting, according to an exemplary aspect of the present disclosure;

FIG. 5 is a cross section view illustrating a method of installing a connector, according to an exemplary aspect of the present disclosure;

FIG. 6 is a cross section view illustrating a glass product, according to an exemplary aspect of the present disclosure;

FIG. 7 illustrates a top view of a sleeve, according to an exemplary aspect of the present disclosure;

FIG. 8 is a cross section view illustrating a method of installing a connector, according to an exemplary aspect of the present disclosure;

FIG. 9 is a cross section view illustrating a glass product, according to an exemplary aspect of the present disclosure;

FIG. 10 is a cross section view illustrating a glass product, according to an exemplary aspect of the present disclosure;

FIG. 11 is a cross section view illustrating a top portion of a connector according to an exemplary aspect of the present disclosure.

FIG. 12 is a cross section view illustrating a top portion of a connector according to an exemplary aspect of the present disclosure; and

FIG. 13 is a cross section view illustrating a top portion of a connector, according to an exemplary aspect of the present disclosure.

### DETAILED DESCRIPTION

In the following description, for purposes of explanation specific details are set forth in order to promote a thorough understanding of one or more aspects of the disclosure. It may be evident in some or all instances, however, that many aspects described below can be practiced without adopting the specific design details described below.

Disclosed herein is a connector, including: a sleeve having an opening therethrough; and a fitting Which fits at least partially within the sleeve, wherein the fitting includes a connector plate on a bottom surface and an extension extending from the fitting. Also disclosed herein is a glass product, including: a glazing having a connectable material with a connecting surface on the glazing; the connector mentioned above; and a conductive material within the sleeve; at least part of the conductive material being positioned between the connector plate and the connecting surface.

Glass products, including automotive glass products, may include glazings and connectors where power is to be supplied to the glazing or an element of the glazing, or where an antenna is connected to a signal receiver. Particularly, a coating Of print may be powered, for example, to be heated. Printed silver, for example, may be located across a glazing, such as heating lines across a rear window, or in a localized area, such as wiper park heating lines. Coatings or printings may require a connector to provide power from an electrical source to heat the coating or print. Antennas may require a connector to reach a signal receiver. A connector may be attached to an outer surface of the glazing, such that in a laminated glazing, the connector may be attached without regard for timing of an autoclave process. In some glazings, a connectable material may be provided on a glazing interior surface and include a glass cutout which may allow for a connector to be attached after the glazing is laminated. Further, some glazings may not be laminated. For example, a rear window may be a tempered glass substrate that is not laminated. Among other things, a method of installing, a connector, as disclosed herein, may advantageously work for both laminated and non-laminated glazings.

An automotive glazing may include a coating or print of material which may be elects connectable. Coatings may, for example, include metals, such as silver, or conductive oxides. In sonic embodiments, the electrically connectable materials may be printed onto the glazing, including by screen printing. For example, silver, or silver alloy, material may be screen printed onto a glass substrate, such as lines across a rear window for heating and melting snow and ice on the window. Printed electrically connectable materials may further be provided in an area of a windshield or rear window where a wiper may sit in an off position. Such a “wiper park” may include a printed silver which is beatable by connection to a power supply. A printed connectable material may be any suitable pattern to provide adequate heating or power to a desired area or areas and may include an area printed for connecting to an electrical connector in some embodiments, the glazing may include an opaque print at a periphery and/or around an accessory, such as a camera or sensor, and the connectable material may be printed on the glass and/or an opaque print. The connectable print may include a connecting surface inch is to be connected to a connector.

A connector may provide a conductive attachment between a power source or receiver and a connectable material. Particularly, a connectable material formed on a glazing may include a busbar or other connecting surface. A connecting surface may include a busbar or another surface for attaching a connector to a connectable material. A busbar may be any suitable form, such as a silver-containing material and/or a metallic tape, such as a copper tape. A copper tape may be positioned over other connectable materials and form a suitable surface for attaching a connector for attaching to a power source or receiver. A busbar may be formed on some glazings as a silver printed busbar. A busbar may be formed to connect a coating, a printed silver layer, an antenna, or any other suitable material to a connector. In some glazings, the busbar may be printed on a black frit on a glass substrate.

In certain embodiments described herein, a connector may be provided which includes a sleeve and a fitting, or plunger, for positioning within the sleeve. The connector may be attached over a connecting surface of a connectable material, such as a busbar, wherein a conductive material is positioned on the busbar within the sleeve. The fitting may fit at least partially within the sleeve and against the conductive material within the sleeve. The fitting may include a connector plate for contacting the conductive material and an extension portion which may connect to a power source or receiver

A suitable sleeve material may include a nonconductive material, including a plastic such as a polycarbonate or polybutylene terephthalate. The sleeve may have sufficient strength such that the sleeve may not change in shape under pressure of conductive material filled therein. An adhesive lay be used on a bottom surface of the sleeve to attach the sleeve to a glazing and to seal the point of attachment. The sleeve may be adhered to the glazing, particularly over a connecting surface on the glazing. The sleeve over the connecting surface may be adhered directly to the connecting surface, the glass surface of the glazing, a printed surface, such as an enamel print, or a combination of two or more of these. A removable liner may be provided over the adhesive prior to installation. The liner may protect the adhesive during transportation and handling prior to its removal and installation of the sleeve. In some embodiments, the adhesive may be a pressure sensitive adhesive or curable by heat or light, such as an ultraviolet light. The sleeve may include feet extending along a bottom edge of the sleeve which may increase the surface area of the sleeve which may be adhered to a glazing. Where the adhesive is provided on the bottom surface of the sleeve, as the sleeve is positioned over the connecting surface, the adhesive may partially spill out from underneath the sleeve so that the adhesive is under the sleeve and at an edge of the sleeve where the Sleeve infects the glazing. The shape of the sleeve bottom surface may be designed to allow spilling out of the adhesive outside of the sleeve rather than inside of the sleeve. For example, the bottom surface may be higher on an outside edge compared to an inside edge of the sleeve bottom surface. Some sleeves may include a bottom surface that has a recess for placement of the adhesive. The shape of the sleeve bottom may be selected, at least in part, by the viscosity of the adhesive. At least a part of the bottom of the sleeve in sonic embodiments may be in a shape to complement the glazing surface or connecting surface shape. Applying an adhesive or a sealing material around the edge of the sleeve her t meets the glazing may improve strength against peeling. An adhesive applied to the bottom of the sleeve may be the same or different from a sealing material applied around a bottom edge of the sleeve. The spilling out of adhesive may further improve protection against moisture or chemicals for the materials within the sleeve. The adhesive may have suitable mechanical strength to maintain the sleeve in position on the glazing. An adhesive tape may be used as such a seal around the bottom edge or on the bottom surface. Such a tape may be a double sided adhesive tape. In some embodiments, the sleeve material may be transparent to ultraviolet light which may be used for curing an adhesive under the sleeve. The adhesive may be, for example, polyurethane resin, epoxy resin, methacrylic resin or silicone resin. The adhesive may be ultraviolet light curing, temperature curing or pressure sensitive. Preferably the adhesive is of a chemistry that will not react with a conductive material within the connector it may be preferable that the materials do not react or migrate such that the conductive and mechanical connections are maintained, respectively.

The fitting may be made of one or multiple materials. For example, the fitting may have a lower portion which includes a connector plate which may be a connectable material, such a metal, including silver, copper, iron, aluminum, or alloys including such metals. The entire fitting may be made of the connectable material of the connector plate, or the fitting may have another material formed above the connector plate in a major portion if the fitting. The major portion of the fitting may be formed of a nonconductive material in some embodiments, such as a resin or plastic. The sleeve may have an opening which the fitting fits within. The shape of the sleeve opening and fitting may complement each other such that the fitting may fit, or clip, within the sleeve. The bottom surface of the fitting, including the connector plate may be a shape that complements the shape of a glazing surface, including the connecting, surface. The complementary shape may reduce inhomogeneities of thickness of conductive material between the connector plate and connecting surface as the surfaces are the same shape, or complementary.

In certain embodiments, the fitting may include at least one clip. The clip may fit into the sleeve, for example, by a cantilever or annular snap fit system.

In certain embodiments, the sleeve may include in an interior wall the of at least one void in which the fitting may extend. The at least one Clip may correspond to the at least one void. The fitting extending into the void or voids of the sleeve may retain the fitting within the sleeve. The materials of the sleeve and fitting may be such that they have sufficient strength to remain attached to each other when installed on a connecting surface, such as a busbar. A void may include a pocket or a through hole. It may be understood that examples discussed herein including pockets may be alternatively provided as connectors having holes formed through the sleeve for attachment with a fitting.

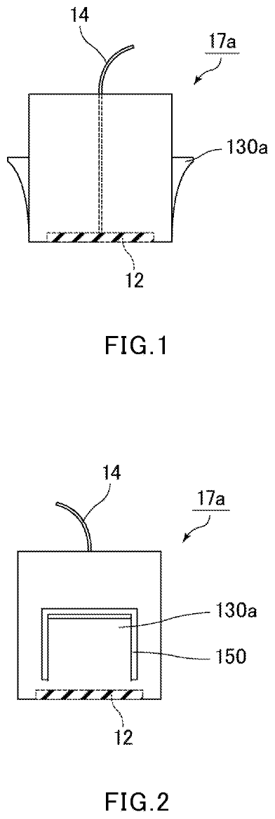

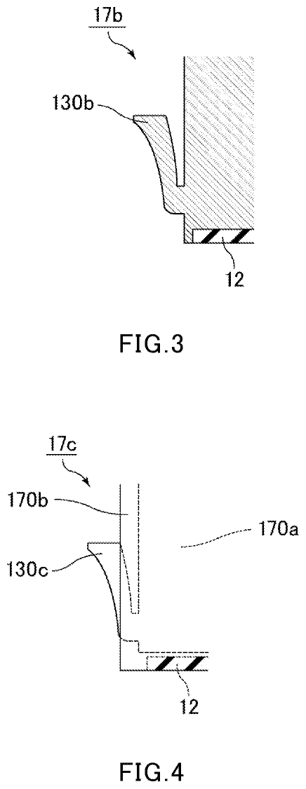

In some embodiments, the number of voids in a sleeve may be equal to the number of clips on the fitting. For example, where h sleeve may include at least two voids, the fitting may include at least two clips. The fitting may have at least two clips which are formed symmetrically around the fitting. For example, where there are two clips 130a, they may be formed opposite each other on the fitting 17a, as shown in FIG. 1. The clips 130a may be flexible, such that during placement. of the fitting 17a within the sleeve, the clips 130a may be at least somewhat retracted until reaching the pockets in the sleeve. When installed, the clips 130a may extend, or snap, into the pockets and prevent removal of the fitting 17a from the sleeve. Particularly, a portion of the fitting 17a along a side to be placed within a sleeve, may extend from a central portion of the fitting 17a to provide a clip 130a. In some embodiments, the fitting 17a may be hollow, such that the clip 130a may retract into the hollow area of the fitting 17a. The fitting 17a may, in some embodiments, be formed as one continuous piece, including at least one clip 130a. An opening 150 may be formed partially around the clip 130a to allow for its retraction during installation, as shown in FIG. 2. An opening 150 may not extend along a bottom edge of a clip 130a which may retain the clip 130a on the fitting 17a. Some clips 130b may be formed attached to the fitting, 17b without an opening around the clip 130b as shown in FIG. 3. The fitting 17b may or may not be hollow with such clips 130b. In some embodiments, the fitting 17c may include an inner piece 170a and an outer shell 170b, and the clips 130c may be formed as part of the inner piece 170a which is within an outer shell 170b, as shown in FIG. 4. The clip 130c may extend through the outer shell 170b and retract into the outer shell 170b during installation. The fitting 17a-c may be reinforced where a clip 130a-c is attached to the fitting body, such that there is strength in the clip 130a-c and the fitting 17a-c may remain within the sleeve over time.

In some embodiments, a connector sleeve may include a single void, such as a pocket, extending around the majority or all of the sleeve. A fitting 17a-c for such a sleeve may include one or more clips 130a-c. A single clip 130a-c may be used where the clip 130a-c material is flexible enough to retract within the sleeve during installation as to provide an annular snap fit. Where a fitting 17a-c and clip 130a-c material is too firm, the pressure required to install a fitting 17a-c having a single clip 130a-c may be unsuitable against an underlying glazing. It is preferable to avoid forming cracks in an underlying glazing. The fitting material may be selected to provide suitable installation to minimize or eliminate formation of such cracks. It may be preferable in some embodiments to provide multiple clips 130a-c which may extend around the fitting 17a-c. In certain embodiments having a single pocket, the clips 130a-c may extend around a majority of the fitting 17a-c.

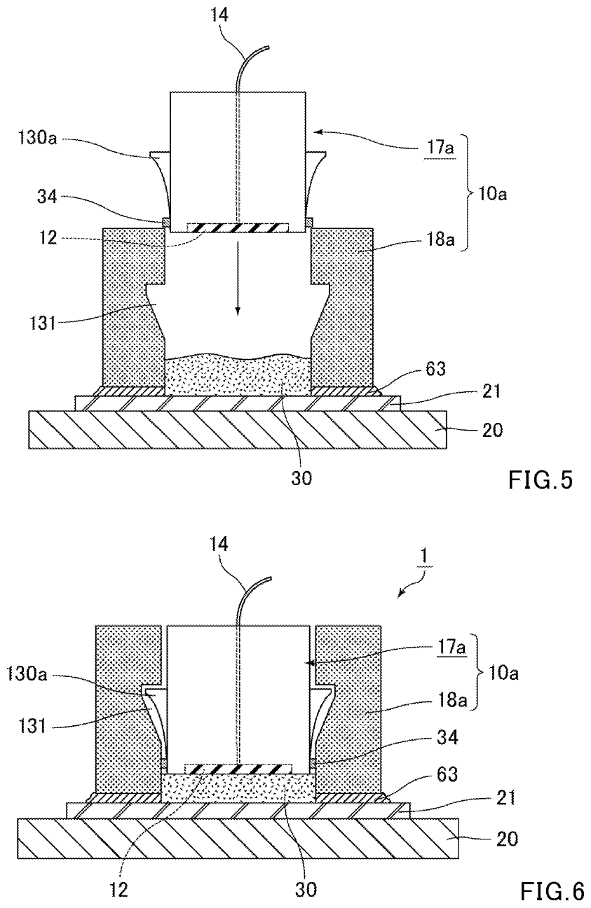

The fitting 17a-c may include a gasket 34 around the fitting 17a-c, such that a suitable seal may be formed between the fitting 17a-c and the sleeve 18a when the connector 10a is installed, as shown in FIGS. 5 and 6. In some embodiments, the gasket 34 may be provided within the sleeve 18a or on the fitting 17a-c. The gasket 34 may be a rubber-based material. The difference in size between an opening in the sleeve 18a and the outer perimeter of the fitting 17a-c may be such that the gasket 34 creates a seal between the sleeve 18a and fitting 17a-c. Such a seal may prevent conductive material 30 within the sleeve 18a from flowing out of the connector 10a. The gasket 34 may also prevent moisture from reaching the conductive material 30. The gasket 34 may be positioned above and/or below the clips 130a-c. The gasket 34 may be preferably below the clips 130a-c when installed on a glazing 20. Where the gasket 34 is below the clips 130a-c, the gasket 34 may prevent the conductive material 30 from reaching such clips 130a-c and voids 131 within the sleeve 18a. In some embodiments, the gasket 34 may be a continuous structure around the fitting outer perimeter.

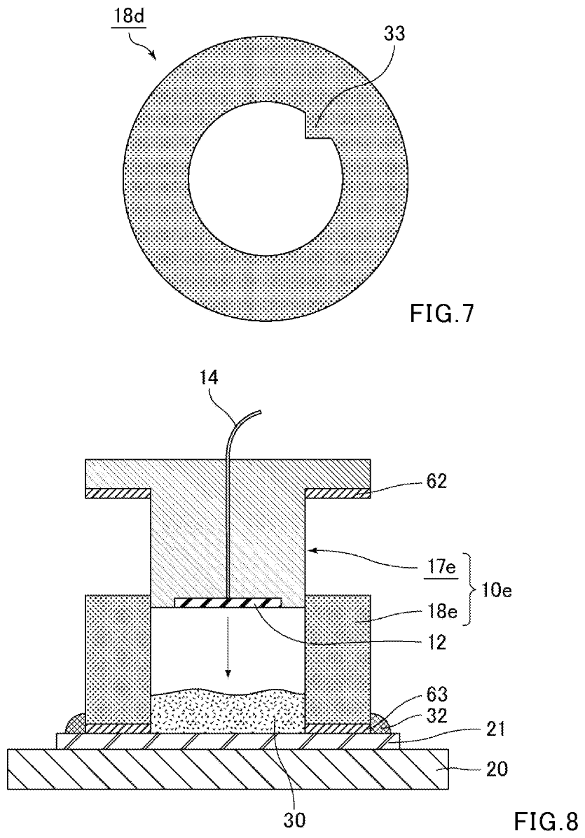

The fitting 17a-c may have an outer shape complementary to that of the sleeve opening. The complementary shapes may be similar in shape, where the fitting outer shape is slightly smaller than the opening of the sleeve 18a such that the fitting 17a-c may be positioned a within the sleeve 18a. The fitting tauter shape and the sleeve opening may preferably have a circular shape. Some further embodiments of the connector 10a may include another shape, such as oval-shaped, hexagonal, square, etc. There may be a notch 33 or other design formed in the matching shapes such that the fitting 17a-c may only be installed in the sleeve 18d in one orientation, as shown FIG. 7. Such a shape may ensure the proper placement of the clips 130a-c in relation to the voids 131 and/or the extension 14. In certain embodiments, the sleeve 18a,d may include an indication of the proper fitting 17a-c orientation for installation. The indication may include a marking which match to a marking on the fitting 17a-c, for example.

In certain embodiments, the fitting 17e may include a top portion which extends over the sleeve 18e when the connector 10e is installed, as shown in FIG. 8. The top portion of the fitting 17e may be adhered to a top surface of the connector sleeve 18e. The top surface of the connector sleeve 18e may include the surface opposite from a surface attached to the underlying glazing 20 at the connecting surface 21. The top portion of the fitting 17e may include a top adhesive 62, which may be the same or different than a bottom adhesive 63 on the bottom surface of the sleeve 18e. The top adhesive 62 on the fitting 17e may be suitable to adhere the fitting 17e to the sleeve 18e and may preferably be pressure sensitive, heat curable, or light curable. The top adhesive 62 may be different from a bottom adhesive 63 for attaching to the glazing 20 in some embodiments as the materials to be adhered may be different. For example, the sleeve 18e may be adhered to a connecting surface 21, such as a busbar, and/or glazing 20, which may include an opaque print (not shown), and the top adhesive 62 may have suitable adhesion to the fitting 17e and the sleeve 18e. In some embodiments, an adhesive 62 to bind the sleeve 18e and fitting 17e together may be provided on a top surface of the sleeve 18e. A liner may be formed on the adhesive 62, 63 formed on the fitting lie or the sleeve 18e. The adhesive 62, 63 formed between the fitting 17e and the sleeve 18e and the connecting surface 21 and/or glazing 20 may suitably protect conductive material 30 within the connector 10e from exposure to moisture, which may interfere with the connection of the connector plate 12 to the connecting surface 21. The adhesive 62, 63 further may provide suitable adhesion between the sleeve 18e and the fitting 17e and the connecting surface 21 and/or glazing 20 to ensure the connector 10e remains installed on a glazing 20 and conductive material 30 remains within the connector 10e. The adhesive 62, 63 may further be of a chemistry compatible with the conductive material 30 such that there is no chemical reaction between the materials that would alter the conductive nature of the conductive material 30 or the chemical structure or mechanical adhesion of the adhesive 62, 63. The top of the fitting 17e may cover the sleeve 18e, and a physical force may be applied over the fitting 17e and the sleeve 18e to install the connector 10e. The fitting 17c may further include a gasket as described above.

The fitting 17a-c,e may include a connector plate 12. In certain embodiments, the connector plate 12 may be a single piece with a fitting 17a-c,e in some embodiments, the connector plate 12 may be adhered and/or press fit in the fitting 17a-c,e, and the fitting 17a-c,e may include an indentation for receiving the connector plate 12. The connector plate 12 may be sized equal to or larger than the indentation to provide a tight fit between the materials. At least part of the conductive material 30 within the sleeve 18a,d-e may be positioned between the connector plate 12 and the connecting surface 21, Preferably, the connector plate 12 forms a seal with the fitting 17a-c,e, such that, when installed, conductive material 30 may not fill around a top surface of the connector plate 12. The connector plate 12 may be a material having suitable conductivity with a conductive strength such that a power source may be adequately attached thereto and provide sufficient conductivity to transfer electrical voltage from the power source to the connectable material or to provide a signal to a receiver. For example, the connector plate 12 may include silver, copper, iron, aluminum, nickel, or alloys including such metals. The connector plate 12 may have a lower surface shape that is flat and/or matches the glazing 20 surface shape. A matching shape between the glazing 20 and the connector plate 12 may reduce inhomogeneities of thickness of the conductive material 30, which may improve conductivity and reduce a risk of creating a hot spot. The fitting bottom surface around the connector plate 12 may further have a shape matching that of the glazing 20 surface shape. The conductive material 30 may increase the area of the connector plate 12 that is in electrical contact with the connecting surface 21 and improve the connection therebetween. The connector plate 12 may come into direct contact with the connecting surface 21 at one or more points in some embodiments. In some embodiments, the conductive material 30 covers the connecting surface 21 within the sleeve 18a,d-e such that the connector plate 12 does not physically contact the connecting surface 21.

As shown in FIG. 1, the connector plate 12 may be attached to an extension 14, which may extend out of the fitting 17a. The extension 14 may be accessible when the connector 10a,e is installed on a glazing 20 and may further be connected to a power source or receiver. The extension 14 may be a suitable material for electrical connection, which may be the same or different from the connector plate 12 material. The extension 14 may be any suitable shape and form for extension through the fitting 17a-c,e from the connector plate 12 and attachment a power source or receiver. The extension 14 may be formed as a single piece with the connector plate 12 or may be attached to the connector plate 12 by suitable means, such as welding, soldering, crimping, riveting, etc. In some embodiments, the extension 14 may be in the form of a wire. In certain embodiments, a wire extension 14 may be attached to the connector plate 12 via a crimp connection where the wire is crimped to the connector plate 12. Where the extension 14 is a wire, the wire may include a nonconductive, insulative casing.

In certain embodiments, the top adhesive 62 may be provided on the fitting 17e or on a top surface of the sleeve 18e so that the top adhesive 62 is in contact with the fitting 17e and the sleeve 18e when the fitting 17e is pushed into the sleeve 18e. Where the adhesive 62 on the fitting 17e or the sleeve 18e is cured by heat or light, the curing means may be applied once the fitting 17e is in place within and on the sleeve 18e.

In some glass products 1, 2, there may be a need for multiple connector 10a,e attachments. The attachments may have the same or different connection means and require the same or different connector extensions 14. With the placement of different connectors 10a,e, it may be important to match the appropriate connecting surfaces 21 for attachment. Where there is more than one connector 10a,e required on a glazing 20, the connectors 10a,e described herein may be used for both connections. The different connectors 10a,e may be distinguishable from each other such that each fitting 17a-c,e may be readily matched to the appropriate sleeve 18a,d-e. The fittings 17a-c,e may be distinguishable, for example, by the size and/or shape of the fitting 17a-c,e and sleeve 18a,d-e opening. Where multiple connectors 10a,e are used, the fittings 17a-c,e may have different outer sizes and/or shapes such that the fittings 17a,c,e may only lock in place within the appropriate sleeve 18a,d-e. The fittings 17a-c,e and sleeves 18a,d-e may further be matched by a color which may indicate a proper match of the connector pieces 17a-c,e, 18a,d-e. Alternatively, as shown in FIG. 10, a connector 10f may have a multiple-compartment sleeve 18f having at least two independent compartments which are electrically isolated from each other. A connecting surface 21 and a conductive 17 material 30 may be disposed in each compartment. A sleeve 18f may have at least one wall 19 dividing adjoining compartments. The sleeve 18f and the wall 19 inlay be non-conductive such that the compartments may remain electrically isolated from one another. The adhesive 62, 63 may also be non-conductive and prevent migration of conductive materials 30 to maintain electrical isolation. The wall 19 may have any suitable shape or height as long as the compartments may remain electrically isolated from each other. A fitting 17f may include at least two connector plates 12 and extensions 14 as described above which provide a suitable connection between the connecting surfaces 21 and a power source or receiver. The fitting 17f may have any suitable shape as long as it fits in the sleeve 18f, including the compartments, and provides a suitable connection.

The connectors 10a,e-f described herein may be attached to a glazing 20, 22 by first positioning a sleeve 18a,d-f over an intended connecting surface 21 on the glazing 20, 22. Prior to positioning the sleeve 18a,d-f, the connecting surface 21, such as a busbar, may be cleaned or burnished or otherwise treated to provide a suitable connection surface. The sleeve 18a,d-f may include a bottom adhesive 63 on a lower surface that is attached to the glazing 20, 22, which may include an opaque print and/or the connecting surface 21. The adhesive 63 may be curable by any suitable means. In some embodiments, the adhesive 63 may be a pressure sensitive adhesive or curable by heat or light in some methods of attaching the connector 10a,e-f, a conductive material 30 may be dispensed in the opening of the sleeve 18a,d-f positioned on the glazing 20, 22. The bottom adhesive 63 between the glazing 20, 22 and the sleeve 18a,d-f may be cured prior to administration of the conductive material 30 in the sleeve 18a,d-f. The amount of conductive material 30 may be controlled to fill a space below the connector plate 12 and the gasket 34, where there is a gasket 34, when the fitting 17a-c,e-f is installed. The conductive material 30 may have a sufficient electrical conductivity to provide a suitable connection between the connector plate 12 and an underlying connecting surface 21, such as a busbar. The conductive material 30, for example, may include: a metal such as silver, copper, or aluminum; a metal containing material such as a metallic paste or an alloy containing the metal; or a carbon material such as graphite or carbon nanotubes. The conductive material 30 may be applied in a form of a paste. For example, a silver paste may be usable as a conductive material 30, A medium may contain 2-(2-ethoxyethoxy)ethyl acetate and other components similar to automotive silver paste. Silver concentration range may be 50 to 90 wt % preferably 80 to 90 wt %, even more preferably 85 to 90 wt %. Viscosity may be 5000-100000 cP (or mPa·s) at 25° C., preferably 9000-35000 el′ (or mPa·s) at 25° C., measured by a rheometer, such as Brookfield DVIII, SC4-14/6R at 0.20 rpm. Sheet resistivity of a silver paste may be 1-10 mΩ/sq at 25 μm, preferably 7-8 mΩ/sq at 25 μm. A solder paste may be usable as a conductive material. it may contain metallic solder alloy powder like SAC alloy [tin-silver-copper flux type Ro10, resin flux. This may be more cost effective than silver paste. The particle size of SAC powder in the flux a may be 1-100 μm, preferably 15 to 45 μm. Metal content in the solder paste may be 50 to 90 wt %, preferably 85 to 90 wt %. Viscosity of the solder paste may be 10000-1000000 cP (mPa·s), preferably 100000-900000 cP (mPa·s). In some embodiments, the conductive material 30 may be compressible such that, under pressure, the conductive material 30 may compress and form a strong electrical connection between an underlying connecting surface 21, such as a busbar, and the connector plate 12. Once the sleeve 18a,d-f is in place, the fitting 17a-c,e-f may be installed within the sleeve 18a,d-f, as shown in FIGS. 5 and 8, by pushing the fitting 17a-c,e-f into the sleeve 18a,d-f, over the conductive material 30 such that the connector plate 12 is in contact with the conductive material 30.

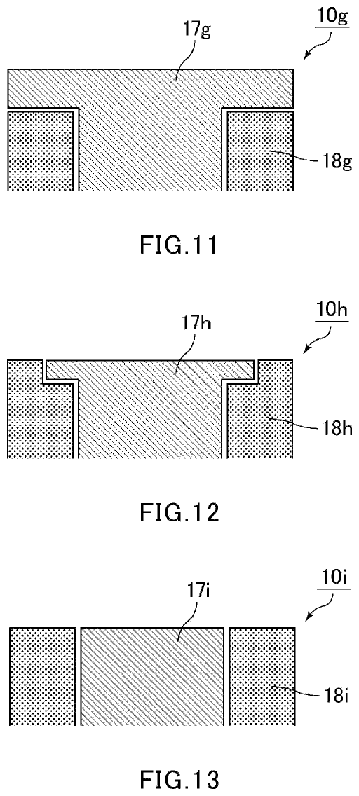

A physical force may be used against, the fitting 17a-c,e-f to push the fitting 17a-e,c-f within the sleeve 18a,d-f. In some embodiments, the clips 130a-c of the connector 10a may retract as the fitting 17a-c is pushed within the sleeve 18a,d. Once the clips 130a-c reach the voids 131, the clips 130a-c may extend into the voids 131, securing the fitting 17a-c within the sleeve 18a,d, as shown in FIG. 6. As shown in FIG. 11, the top of the fitting 17g may cover the sleeve 18g. FIG. 12 illustrates another fitting 17h which may provide an even surface with the sleeve 18h. Another fitting 17i having an even surface with the sleeve 18i is shown in FIG. 13. Where the fitting 17a-c,h-i provides an even surface with the sleeve 18a,d,h-i, a technician may be able to readily recognize when a fitting 17a-c,h-i is installed within the sleeve 18a,d,h-i based on the even surface. In some embodiments, the sleeve 18a,d,h-i, may include a shelf for receiving a top of the fitting 17i, as shown in FIG. 12. Where a physical force is applied to install the fitting 17a-c,e-i, the force may also be applied to the sleeve 18a,d-i and an adhesive 62, 63 on the sleeve 18a,d-i and/or fitting 17e-h. Where a connector 10a,e-i is provided on a laminated glazing 20, 22, the connector 10a,e-i may be applied before or after lamination.

FIG. 1 illustrates a fitting 17a according to some embodiments. The fitting 17a may have two clips 130a, a connector plate 12 and an extension 14. —FIG. 2 illustrates an opening 150 formed partially around. the clip 130a on the fitting 17a.

FIG. 3 illustrates a part of a fitting 17b according to some embodiments. The fitting 17b may have at least one clip 130b which is attached to or formed as pail of the fitting 17b and may be flexible.

FIG. 4 illustrates a part of a fitting 17c according to some embodiments. As shown in FIG. 4, the fitting 17c may have an inner fitting 170a and outer shell 170b. The clip 130c which is attached to or formed as part of the inner fitting 170a may extend through the outer shell 170b.

FIG. 5 illustrates a method of installing a connector 10a including a fitting 17a and a sleeve 18a according to some embodiments. As shown in FIG. 5, the connector 10a may be applied to a glazing 20 by positioning the sleeve 18a over a connecting surface 21 on the glazing 20 with a first, bottom adhesive 63 between the sleeve 18a and the glazing 20; dispensing a conductive material 30 in the opening of the sleeve 18a; and pushing the fitting 17a into the sleeve 18a, over the conductive material 30 such that the connector plate 12 is in contact with the conductive material 30 and the clips 130a respectively fit in the corresponding voids 131 in an interior wall of the sleeve 18a. The connector plate 12 may have an extension 14 as described above. The adhesive 63 shows spill out from under the bottom surface. The fitting 17a may have a gasket 34. FIG. 6 illustrates a glass product 1 thus obtained.

FIG. 7 illustrates a top view of a sleeve 18d according to some embodiments which may have a notch 33.

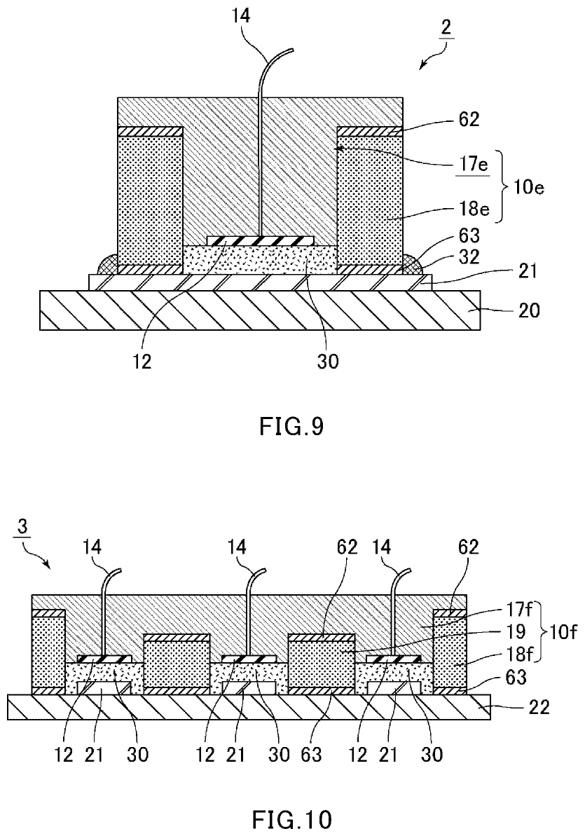

FIG. 8 illustrates a method of ‘installing a connector 10e including a fitting 17e and a sleeve 18e according to some embodiments. As shown in FIG. 8, the connector 10e may be applied to a glazing 20 by positioning the sleeve 18e on a connecting surface 21 on the glazing 20 with a first, bottom adhesive 63 between the sleeve 18e and the glazing 20; dispensing a conductive material 30 in the opening of the sleeve 18e; and pushing the fitting 17e with a second, top adhesive 62 provided thereon into the sleeve 18e, over the conductive material 30 such that a connector plate 12 on the fitting 17e is in contact with the conductive material 30 and the top adhesive 62 is in contact with both the sleeve 18e and the fitting 17e. An additional seal 32 may be provided on the bottom edge of the sleeve 18e to provide additional adhesion and/or chemical protection. The connector plate 12 may have an extension 14 as described above. FIG. 9 illustrates a glass product 2 thus obtained. The fitting 17e may further include a gasket 34 to prevent flow of the conductive material 30 between the fitting 17e and the sleeve 18e.

FIG. 10 illustrates another embodiment of the glass product. As shown in FIG. 10, the glass product 3 may have a glazing 22 and a connector 10f thereon which includes a fitting 17f and a multiple-compartment sleeve 18f having at least two independent compartments electrically isolated from each other. Each of the compartments includes a conductive material 30 and a corresponding connecting surface 21 on the glazing 22. The sleeve 18f may include walls 19 between adjoining compartments. Each part of the fitting 17f corresponding to a compartment may include at least one connector plate 12 and corresponding extension 14, which may be electrically connected to an underlying connecting surface 21 in the compartment. A fitting 17f may include at least two compartments, and thus, at least two connector plates 12 and extensions 14. A conductive material 30 may be positioned at least partially between the connector plate 12 and the connecting surface 21. The sleeve 18f and the walls 19 may be adhered to the glazing 22 with a first, bottom adhesive 63. The fitting 17f may be adhered to the sleeve 18f and the walls 19 with a second, top adhesive 62.

FIGS. 11 to 13 illustrate various embodiments of connectors. As shown in FIG. 11, the connector 10g may include a fitting 17g which covers a sleeve 18g. As shown in FIG. 12, the connector 10h may include a sleeve 18h which includes a shelf for receiving a top of a fitting 17h. The top portion of the fitting 17h may be positioned over the sleeve 18h at the shelf. The fittings 17g,h may be attached to the sleeves 17g,h, respectively, using means described herein, including clips 130a-c and voids 131 or with a top adhesive 62. The means of attachment are not shown in FIGS. 11 to 13. As shown in FIG. 13, the connector 10i may include a fitting 17i which provides an even surface with a sleeve 18i. The fitting 17i may be attached to the sleeve 18i via clips 130a-c and voids 131.

Particular spatial terms such as “bottom” and “above” are used herein to describe the glass product or the connector in its orientation shown in the drawings and are not intended to be ab solute.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glass product, comprising:
a glazing having a connectable material with a connecting surface on the glazing;
a connector over the connecting surface including: a sleeve having an opening, therethrough adhered over the connecting surface via a first adhesive and a fitting which fits at least partially within the sleeve and includes a connector plate on a bottom surface and an extension extending from the fitting; and
a conductive material within the sleeve; at least part of the conductive material being positioned between the connector plate and the connecting surface.

2. The glass product according to claim 1, wherein the sleeve includes at least one void in an interior wall of the sleeve and wherein the fitting includes at least one clip which corresponds to the at least one void.

3. (canceled)

4. (canceled)

5. (canceled)

6. (canceled)

7. (canceled)

8. (canceled)

9. The glass product according to claim 1, further comprising a gasket around the fitting.

10. The glass product according to claim 1, wherein the fitting includes a top portion for positioning over the sleeve and a second adhesive between the top portion of the fitting and a top surface of the sleeve.

11. The glass product according to claim 10, wherein the first adhesive and the second adhesive are the same material.

12. The glass product according to claim 1, wherein the connector plate is press fit into the fitting.

13. (canceled)

14. (canceled)

15. A connector, comprising:
a sleeve having an opening therethrough; and
a fitting Which fits within the sleeve, wherein the fitting includes a connector plate on a bottom surface and an extension extending from the fitting.

16. The connector according to claim 15, wherein the sleeve includes at least one void in an interior wall of the sleeve and wherein the fitting includes at least cane clip which corresponds to the at least one.

17. (canceled)

18. (canceled)

19. (canceled)

20. (canceled)

21. (canceled)

22. (canceled)

23. (canceled)

24. The connector according to claim 15, further comprising a gasket around the fitting.

25. The connector according to claim 15, wherein the fitting includes a top portion for positioning over the sleeve; and a second adhesive provided on at least one of the top portion of the fitting and a top surface of the sleeve.

26. The connector according to claim 25, further comprising a first adhesive on a bottom surface of the sleeve, wherein the first adhesive and the second adhesive are the same material.

27. The connector according to claim 25, wherein the second adhesive is provided on the top portion of the fitting.

28. The connector according to claim 25, wherein the second adhesive is provided on the top surface of the sleeve.

29. The connector according to claim 15, wherein the connector plate is press fit into the fitting.

30. (canceled)

31. (canceled)

32. A method of installing the connector according to claim 15, comprising:
positioning the sleeve on a glazing connecting surface with a first adhesive between the sleeve and the glazing;
dispensing a conductive material in the opening of the sleeve; and
pushing the fitting into the sleeve, over the conductive material such that the connector plate is in contact with the conductive material.

33. The method according to claim 32, wherein the conductive material fills a space between the connector plate and the connecting surface.

34. The method according to claim 32, wherein the first adhesive is cured prior to dispensing the conductive material in the opening of the sleeve.

35. The method according to claim 32, wherein the fitting includes a top portion for positioning over the sleeve and a second adhesive is provided on the top portion of the fitting for adhering the fitting to the sleeve.

36. The method according to claim 32, wherein the fitting includes a top portion for positioning over the sleeve and a second adhesive is provided on the top surface of the sleeve for adhering the fitting to the sleeve.

37. The method according to claim 35, further comprising curing the second adhesive.

38. (canceled)
